(19) United States
(12) Patent Application Publication
(10) Pub. No.: US 2017/0088925 A1
(43) Pub. Date: Mar. 30, 2017

(54) THERMO-MECHANICAL STABILIZATION OF NITINOL WIRES IN AN OPTICAL IMAGE STABILIZATION SUSPENSION

(71) Applicant: HUTCHINSON TECHNOLOGY INCORPORATED, Hutchinson, MN (US)

(72) Inventors: Dean E. Myers, Stewart, MN (US); Bryan J. Scheele, Hutchinson, MN (US); Daniel W. Scheele, Hutchinson, MN (US); Peter F. Ladwig, Hutchinson, MN (US); Richard R. Jenneke, Hutchinson, MN (US)

(21) Appl. No.: 15/279,494

(22) Filed: Sep. 29, 2016

Related U.S. Application Data
(60) Provisional application No. 62/234,795, filed on Sep. 30, 2015.

(51) Int. Cl. C22F 1/00; G03B 5/00; C22F 1/10

(52) U.S. Cl. CPC C22F 1/006; C22F 1/10; G03B 5/00; G03B 2205/0076

(57) ABSTRACT

A method and system for stabilizing properties of shape memory alloy (SMA) wires in an optical image stabilization (OIS) suspension of the type having a first or support assembly and a second or moving assembly coupled with respect to one another by the SMA wires. Embodiments of the method comprise cyclically mechanically straining and de-straining the wires by moving the moving and support assemblies with respect to one another while heat is applied to the wires. The temperature, strain, and de-strain levels are configured to cause the wires to cyclically transition between austenite and martensite phases during the mechanical straining and de-straining.

### REFERENCE TO RELATED APPLICATION

This application claims the benefit of U.S. Provisional Application No. 62/234,795 filed on Sep. 30, 2015 and entitled Thermo-Mechanical Stabilization of Nitinol Wires in an Optical Image Stabilization Suspension, which is incorporated herein by reference in its entirety and for all purposes.

### FIELD OF THE INVENTION

The invention relates generally to methods for manufacturing camera lens suspensions such as those incorporated into mobile phones, tablets and other personal devices. In particular, the invention relates to a method for stabilizing the electrical performance of such camera lens suspensions having shape memory alloy (SMA) wires, such as nitinol wires, used to actuate the suspensions.

### BACKGROUND

PCT International Application Publication Nos. WO 2014/083318 and WO 2013/175197 disclose a camera lens optical image stabilization (OIS) suspension system that has an upper or moving assembly (to which a camera lens element can be mounted) supported by a flexure element or spring plate on a bottom or stationary support assembly. The flexure element, which is formed from metal such as phosphor bronze, has a moving plate and flexures. The flexures extend between the moving plate and the stationary support assembly and function as springs to enable the movement of the moving assembly with respect to the stationary support assembly. The moving assembly and support assembly are coupled by nitinol or other shape memory alloy (SMA) wires extending between the assemblies. Each of the SMA wires has one end attached to the support assembly, and an opposite end attached to the moving assembly. During operation of the suspension system, the SMA wires are selectively driven by electrical signals to move the moving assembly with respect to the support assembly to actuate the suspension. The above-identified PCT publications are incorporated herein by reference for all purposes.

At least in part because of the phase change-related properties of the SMA wires, the wires are typically subjected to a stabilization process, also sometimes known as “burn in,” as part of the manufacture of these suspensions. A purpose of the stabilization process is to stabilize characteristics such as wire stroke length and resistance asymmetry to provide a stable condition for calibration and to enhance the consistency and accuracy of the suspension's operation. During known stabilization processes the assembled suspensions are electrically connected to a controller, and electrical drive signals are repeatedly applied to the device to cycle the wires through the phase changes. This electrical burn in (EB) stabilization process requires relatively complicated equipment and is relatively time consuming to perform.

There remains a continuing need for improved methods for manufacturing suspensions of these types. In particular, there is a need for such suspension manufacturing methods that are effective, robust and efficient to perform. A burn in stabilization process that meets these objectives would be especially desirable.

### SUMMARY

Embodiments of the invention include a method and system for stabilizing properties of shape memory alloy (SMA) wires in an optical image stabilization (OIS) suspension of the type having a first or support assembly and a second or moving assembly coupled with respect to one another by the SMA wires. In embodiments, the method comprises cyclically mechanically straining and de-straining the wires by moving the moving and support assemblies with respect to one another. Heat can be applied to the wires while mechanically straining and de-straining the wires. The temperature, strain, and de-strain levels are configured to cause the wires to cyclically transition between austenite and martensite phases during the mechanical straining and de-straining.

### BRIEF DESCRIPTION OF THE DRAWINGS

FIG. 1 is an illustration of a thermo-mechanical stabilization system in accordance with embodiments of the invention, with optical image stabilization (OIS) suspensions on the stabilization system.

FIG. 2 is detailed illustration of a portion of the system shown in FIG. 1, including an OIS suspension.

FIG. 3 is an illustration of an alternative releasable mounting structure for use with the system shown in FIG. 1.

FIG. 4 is an illustration of an alternative releasable mounting structure for use with the system shown in FIG. 1.

FIG. 5 is a graph of stress v. strain at constant wire temperature (105 deg C) representing a Nitinol wire having 100 repeated cycles or phase transitions from unstressed austenite to stressed martensite showing stabilization of stress plateau and strain offset properties in accordance with embodiments of the invention.

FIG. 6 is a graph of measured average wire resistance asymmetry v. test conditions for OIS suspensions subjected to thermo-mechanical burn in accordance with embodiments of the invention and prior art electrical burn in (EB). Resistance asymmetry is a ratio characterization of measured wire resistance between the strained and de-strained states.

FIG. 7 is a graph of measured average actuator stroke v. test conditions for OIS suspensions subjected to thermo-mechanical burn in accordance with embodiments of the invention and prior art EB.

FIG. 8 is an illustration of an embodiment of an apparatus in accordance with embodiments of the invention that can thermally and mechanically stabilize SMA wire performance before the wire is installed within an OIS actuator assembly.

### DESCRIPTION OF THE INVENTION

Embodiments of the invention include a thermo-mechanical stabilization or burn in system and process for shape memory alloy (SMA) optical image stabililzation (OIS) suspensions. During the thermo-mechanical stabilization process, upper or moving sections or assemblies of the suspensions are reciprocally moved with respect to the bottom or stationary support sections or assemblies to alternately tension and de-tension or recover (i.e., to strain and de-strain or recover) the SMA wires while the wires are heated or otherwise maintained at a predetermined temperature. In embodiments, the moving and support assemblies of the suspensions are alternately tensioned and de-tensioned by amounts and at a temperature at which this action and heat causes the SMA wires to cyclically undergo phase transitions between the austenite and martensite phases. The temperature and amounts of tension and de-tension can be selected to optimize stabilization results and to minimize possible damage to the wires (e.g., work hardening of the wires). Other parameters that can be varied to optimize the stabilization results include the number of strain cycles and the frequency of strain or cycles.

In embodiments, the stationary support assemblies of a plurality of the suspensions are fixedly mounted to a stationary plate that is heated by a heater. The plurality of associated moving assemblies of the suspensions are mounted to an upper moving plate. The upper moving plate is reciprocally driven in a back-and-forth manner with respect to the stationary plate to move the moving assemblies with respect to the stationary support assemblies of the suspensions during the stabilization process.

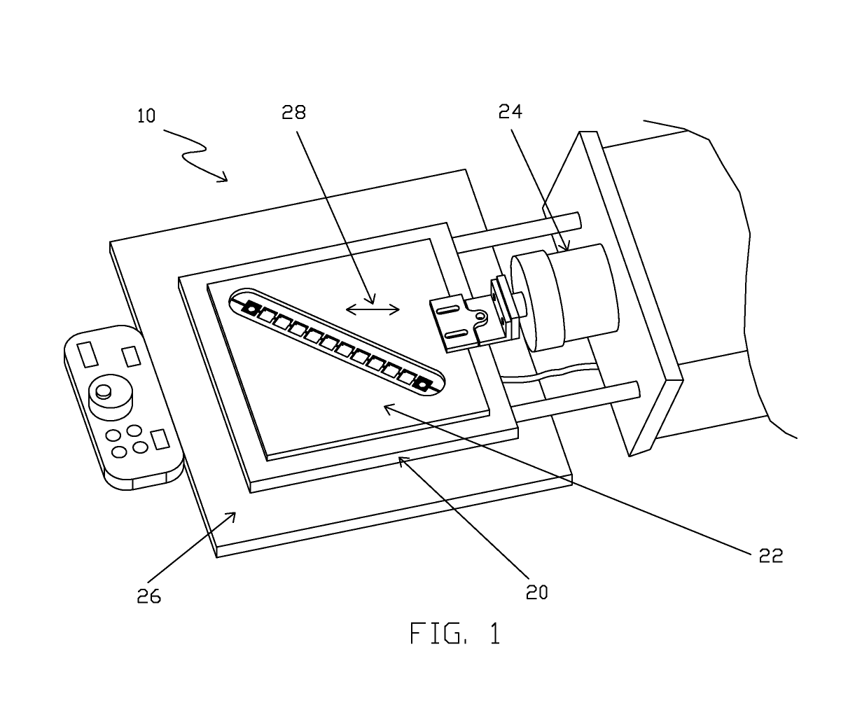

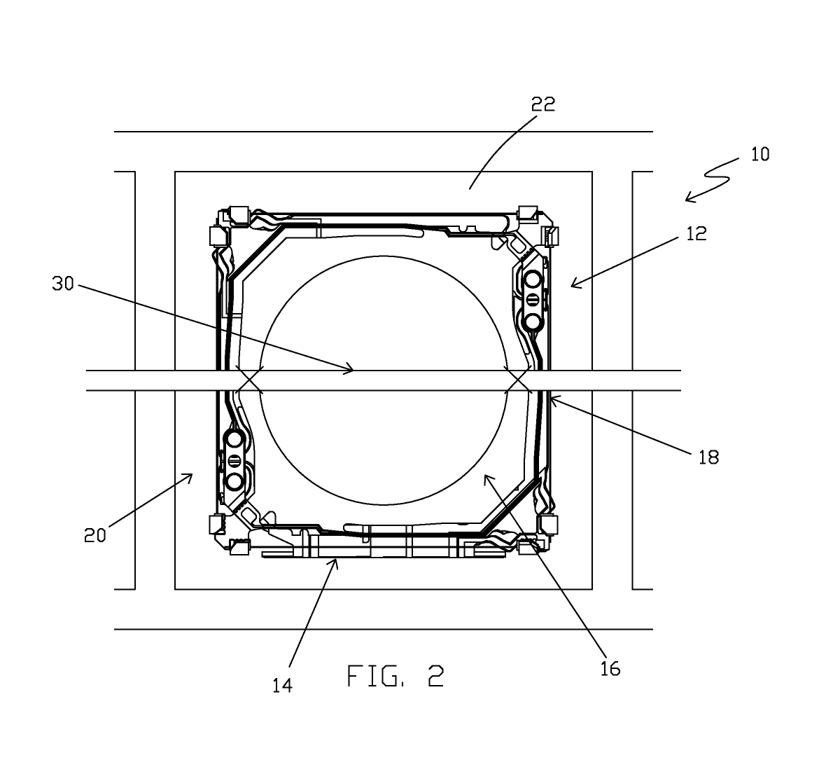

For example, FIGS. 1 and 2 illustrate a thermo-mechanical stabilization or burn in system 10 and process in accordance with embodiments of the invention and shape memory alloy (SMA) optical image stabilization (OIS) suspensions 12 that can be processed by the system and method. As shown in FIG. 2, an exemplary OIS suspension 12 includes a stationary support or bottom assembly 14, a moving or upper assembly 16, and SMA wires 18. Each of the wires 18 extends between the bottom assembly 14 and the upper assembly 16. The illustrated embodiment of OIS suspension 12 has four SMA wires 18 arranged in a rectangular pattern, although other embodiments (not shown) have greater or lesser numbers of such wires. System 10 includes a stationary or bottom plate 20, a moving or top plate 22, actuator 24 and heater 26. In the illustrated embodiment, heater 26 is a hot plate that heats the suspensions 12 through the bottom plate 20. In other embodiments (not show), for example, the heater can be a heated air gun or an oven in which the system 10 is operated. Actuator 24 is a voice coil shaker in the illustrated embodiment, and reciprocally moves the top plate 22 (e.g., about path or axis 28). A controller (not shown) is coupled to the actuator and optionally the heater.

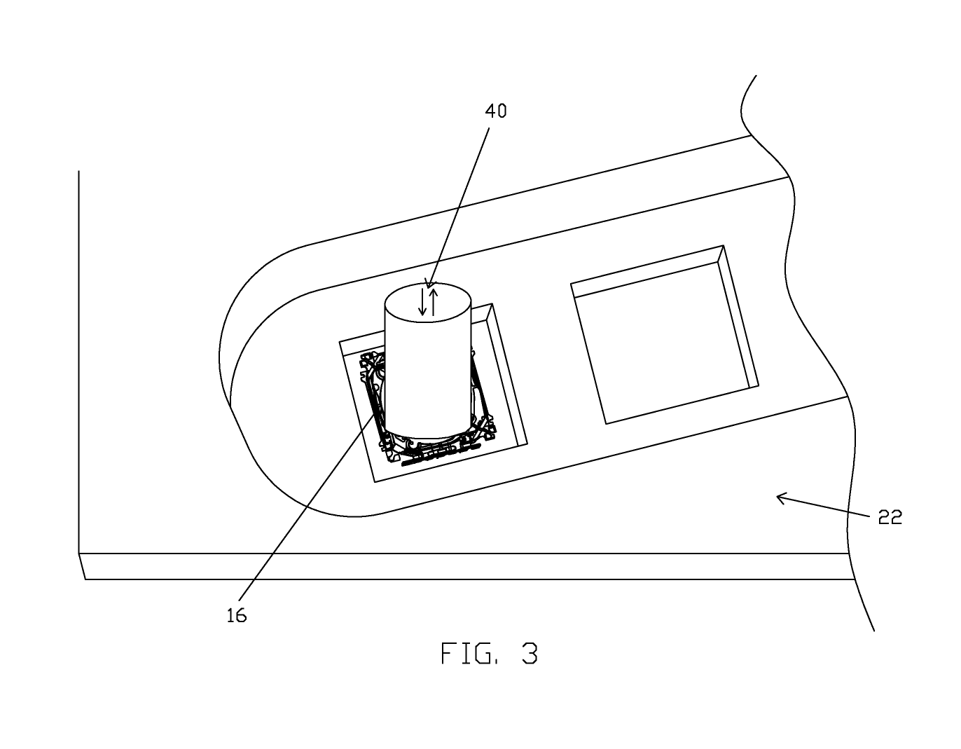

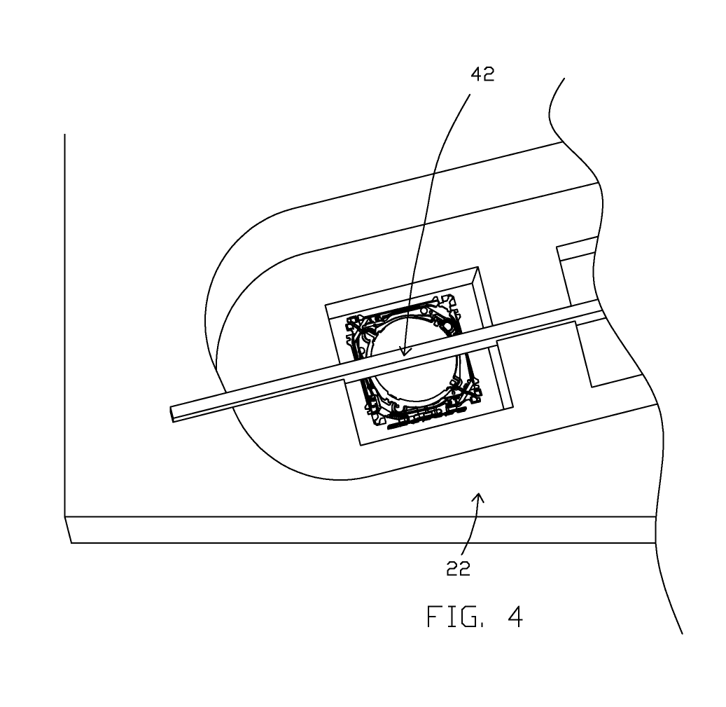

During a stabilization procedure, the bottom assembly 14 of each suspension 12 is mounted to the bottom plate 20 of the system 10, and the upper assembly 16 of each suspension is mounted to the top plate 22. Embodiments of the system 10 include mounting structure (not visible) enabling the bottom assembly 14 of each suspension 12 to be coupled to the bottom plate 20 during the stabilization procedure, and released and removed from the plate following the procedure. Similarly, a mounting structure such as the rod 30 shown FIG. 2 can couple the upper assembly 16 of each suspension 12 to the top plate 22. In embodiments, system 10 can include structures such as the pin 40 of FIG. 3 or the key stock 42 of FIG. 4 to engage the opening in the upper assembly 16 and couple the upper assembly to the top plate 22 during the stabilization procedure, and released and removed from the plate following the burn in procedure. In the illustrated embodiment the suspensions 12 are mounted at an angle (e.g., 45°) with respect to the mechanical motion axis 28, enabling pairs of SMA wires 18 sharing a moving crimp to be simultaneously strained or de-strained by the movement of the top plate 22 about the axis 28. Other embodiments (not shown) are configured for OIS suspensions that have fewer or more than four SMA wires, and/or such wires that have other geometrical configurations. In these and other embodiments, the stabilization system and method can be configured to operate on fewer than all the wires at the same time.

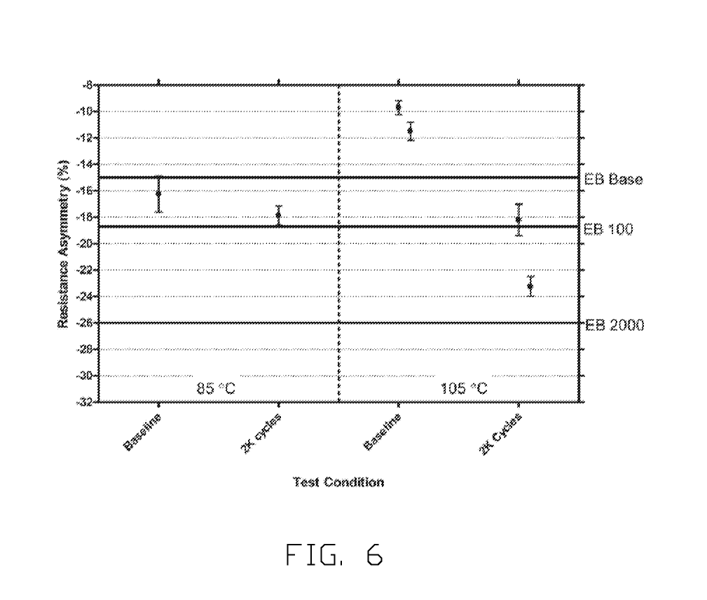

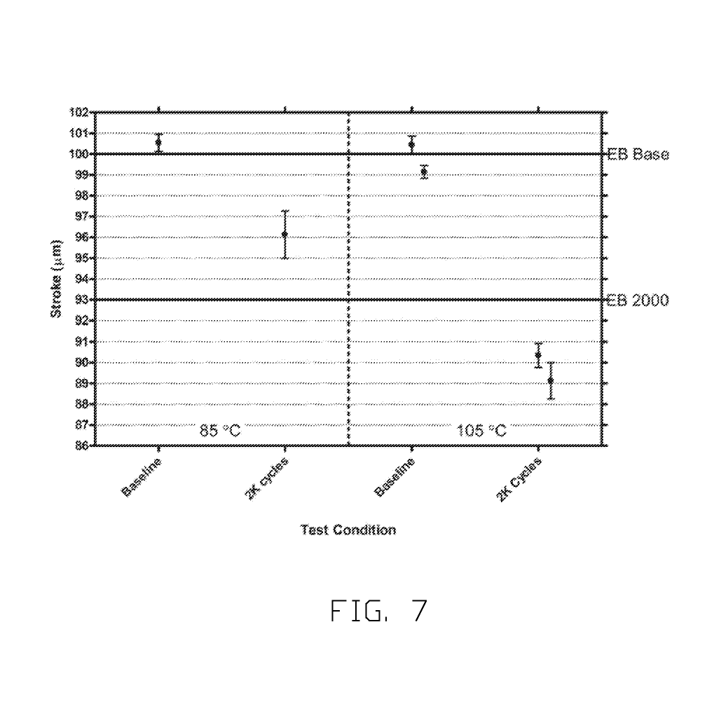

By way of example, suspensions having four nitinol wires were subjected to a stabilization procedure in accordance with embodiments at parameters including a temperature of 105° C. and two thousand cycles at 15 Hz. Measured parameters of the parts following the stabilization included (1) average part movement at cold temperature of 163.4 μm˜2.4% strain, and (2) measured part movement at hot temperature of 142.5 μm˜2.1% strain. Other stabilization process test parameters included 125 cycles at 30 Hz (approximately 4 sec.) and 85° C. These test parameters produced part test results having a mean±1 standard deviation shown in FIGS. 6 and 7 as single (85 deg C) or replicated (105 deg C) data points.

Yet other embodiments of the invention include other structures and methods for providing the relative movement between the moving and stationary support assemblies of the suspensions. For example, the moving assemblies of the suspensions can be free from engagement by the system while the stationary support assemblies of the suspensions are driven at frequencies and over distances that cause the desired relative movement between the moving and stationary support assemblies. Stated alternatively, the inertia of the moving assemblies, when unconstrained by structures other than those of the suspensions themselves, results in the relative movement when the stationary support assemblies are driven.

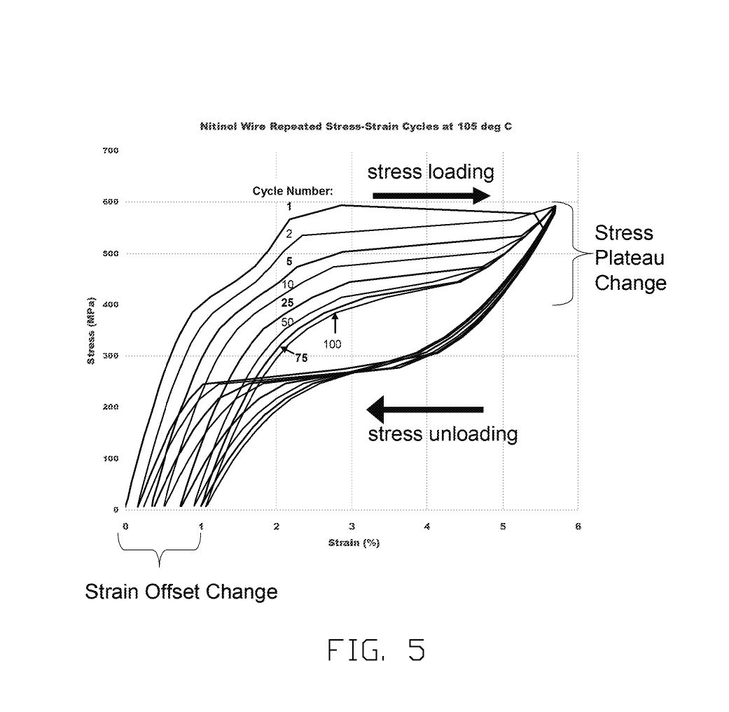

Embodiments of the invention provide significant advantages. The method stabilizes nitinol wire electrical performance using the heat and repetitive mechanical strain. The heated nitinol wires within the OIS suspension are repeatedly mechanically driven during manufacturing to provide a stable position calibrated to the wire's resistance properties. The thermo-mechanical stabilization process (1) uses less complex process equipment than prior art approaches through elimination of electrical pinning, (2) facilitates longer burn in for better stabilization, and (3) provides for enhanced product stiffness during test. As shown by FIG. 5, embodiments of the invention can strain wire between austenite and martensite phases at a constant temperature before the wire is installed within an OIS actuator assembly. The stress plateau stabilization during wire loading (increasing stress) and strain offset stabilization during wire unloading (decreasing stress) are correlated to changes in a wire's stroke and resistance properties within an OIS actuator. With respect to prior art approaches using a thirty second, one hundred cycle electrical burn in (EB) process, embodiments of the invention have been able to provide the equivalent stroke burn in of two thousand electrical burn in cycles and an equivalent resistance asymmetry burn in of one hundred electrical burn in cycles at 105° C. and ±2.1% strain cycling. FIG. 6 is a graph of measured asymmetry of suspensions stabilized using embodiments of the invention (test conditions of two thousand cycles at 85° C. and 105° C.). For purposes of reference, baseline values and corresponding measured values using one hundred and two thousand EB cycles are also shown. FIG. 7 is a graph of measured stroke of suspensions stabilized using embodiments of the invention (test conditions of two thousand cycles at 85° C. and 105° C.). For purposes of reference, baseline values and corresponding measured values using two thousand EB cycles are also shown.

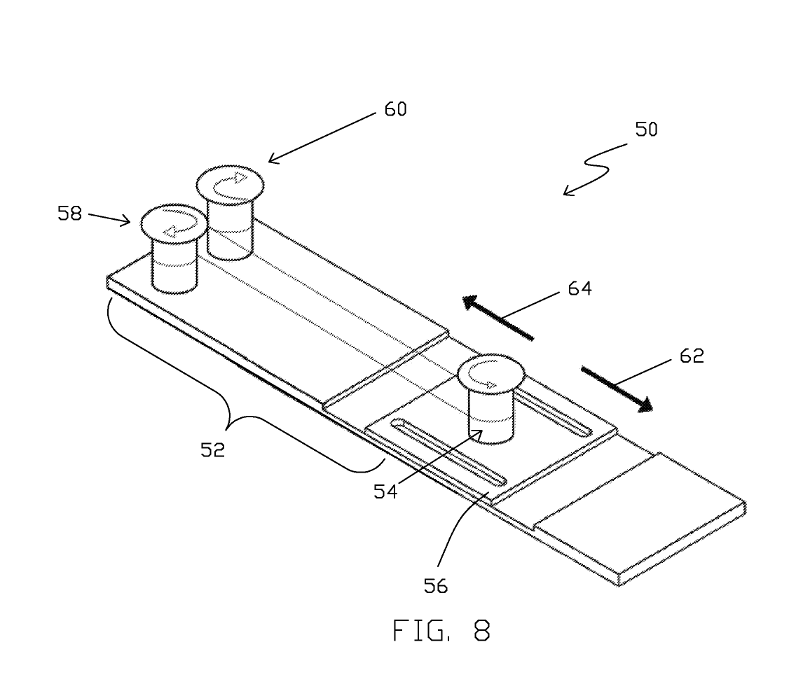

In other embodiments, the shape memory wire is subjected to thermo-mechanical burn in stabilization procedures before it is attached to the OIS suspensions. For example, lengths of the wire can be unwound from a supply spool and rewound on a different spool after the wire has traveled through a heated zone. The straining and de-straining of the wire during the heat zone dwell time can be accomplished by wire travel around single or multiple idler rollers affixed to a moving and controlled linear stage. FIG. 8, for example, illustrates an apparatus 50 having a wire heat zone 52, an idle roller 54 on a surface 56 that can move with respect to heat zone 52, un-spool drive roller 58 and re-spool drive roller 60. Roller 54 can be moved by surface 56 to increase strain (indicated by arrow 62) and to decrease strain (indicated by arrow 64) in the wire in the heat zone 52. Alternatively, the idler roller can be stationary or non-existent for embodiments in which one or both drive rollers have their rotational speed adjusted to induce strain changes in the wire that is suspended in the heat zone. The heat zone could represent wire travel through convective, conductive or radiated equipment. After the length and/or resistance properties of wire are stabilized, it can be installed within an OIS actuator having subsequent electrical burn in processes eliminated or minimized with respect to cycle time.

Although the invention has been described with reference to preferred embodiments, those skilled in the art will recognize that changes can be made in form and detail without departing from the spirit and scope of the invention.

What is claimed is:

1. A method for stabilizing properties of shape memory alloy (SMA) wires in an optical image stabilization suspension of the type having a support section and a moving section coupled with respect to one another by the SMA wires, the method comprising cyclically mechanically straining and de-straining the wires by moving the moving and support sections with respect to one another.

2. The method of claim 1 and further including straining and de-straining the wires to cause the wires to cyclically transition between austenite and martensite phases.

3. The method of claim 1 and further including applying heat to the wires while mechanically straining and de-straining the wires.

4. The method of claim 3 wherein the temperature, strain, and de-strain levels are configured to cause the wires to cyclically transition between austenite and martensite phases during the mechanical straining and de-straining.

5. The method of claim 1 wherein moving the moving and support sections with respect to one another includes driving at least one of the moving and support sections with respect to one another.

6. The method of claim 5 including retaining one of the moving and support sections stationary while driving the other of the moving and support sections.

7. The method of claim 1 wherein moving the moving and support sections with respect to one another includes moving the moving and support sections with respect to one another about a path that is non-parallel to at least some of the SMA wires.

8. The method of any of claim 7 wherein moving the moving and support sections with respect to one another includes moving the moving and support assemblies about a path that is offset by about 45 degrees to at least some of the SMA wires.

9. A stabilization system for performing thermo-mechanical burn in of SMA wires of an optical image stabilization (OIS) suspension having a moving assembly coupled to a support assembly by the SMA wires, including:
a fixture for holding one or more of the OIS suspensions;
an actuator coupled to the fixture for moving the moving assembly of each suspension with respect to the support assembly of each associated suspension to cyclically mechanically strain and de-strain the wires.

10. The stabilization system of claim 9 and further including a heater.

11. The stabilization system of claim 10 and further including a controller coupled to the actuator and heater.

12. The stabilization system of claim 9 and further including a controller coupled to the actuator.

13. The stabilization system of claim 9 wherein the fixture and actuator are configured such that the actuator moves the moving assembly with respect to the support assembly about a path that is non-parallel with at least one of the SMA wires.

14. The stabilization system of claim 13 wherein the fixture and actuator are configured to such that the actuator moves the moving assembly with respect to the support assembly about a path at a 45° angle with at least one of the SMA wires.

15. A method for stabilizing properties of shape memory alloy (SMA) wire, comprising cyclically mechanically straining and de-straining the SMA wire.

16. The method of claim 15 and further including heating and maintaining the wire at a predetermined temperature while mechanically straining and de-straining the wire.

17. The method of claim 16 wherein maintaining the wire at a predetermined temperature includes heating the wire.

18. The method of claim 15 wherein:
the method further includes supporting the wire between at least first and second support members; and
straining and de-straining the SMA wires includes actuating at least one of the at least first and second support members.

19. The method of claim 18 wherein actuating at least one of the at least first and second support members includes moving the first support member with respect to the second support member.

20. The method of claim 18 wherein actuating at least one of the at least first and second support members includes rotating at least one of the first and second support members.
